(19) United States
(12) Patent Application Publication
(10) Pub. No.: US 2021/0164170 A1
(43) Pub. Date: Jun. 3, 2021

(54) Process for the manufacture of lignocellulosic fibreboard

(71) Applicant: SAINT-GOBAIN ISOVER, Courbevoie (FR)

(72) Inventor: Arnaud SOISSON, Paris (FR)

(73) Assignee: SAINT-GOBAIN ISOVER, Courbevoie (FR)

(21) Appl. No.: 17/106,322

(22) Filed: Nov. 30, 2020

(30) Foreign Application Priority Data
Dec. 2, 2019 (FR) 1913609

(51) Int. Cl. D21J 1/20; D21J 1/04; D21J 1/10

(52) U.S. Cl. CPC D21J 1/20; D21J 1/10; D21J 1/04

(57) ABSTRACT

A process for the manufacture of lignocellulosic fiber-based insulation boards that includes: applying a binder composition to lignocellulosic fibers; forming a lignocellulosic fiber mat by compressing the lignocellulosic fibers impregnated with the binder composition; and heating the compressed lignocellulosic fiber mat so as to obtain a lignocellulosic fiberboard bound by an insoluble and infusible thermoset binder, where the binder composition is an emulsion of a poly(methylene diphenyl isocyanate) (pMDI) in an aqueous phase comprising water and a polyol in dissolved form.

### CROSS-REFERENCE TO RELATED APPLICATIONS

The present application is based on, and claims benefit to, French Application FR 1913609, filed on Dec. 2, 2019.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### INCORPORATION-BY-REFERENCE OF MATERIAL SUBMITTED ON A COMPACT DISC

Not applicable.

### STATEMENT REGARDING PRIOR DISCLOSURES BY THE INVENTOR OR A JOINT INVENTOR.

Not Applicable.

### BACKGROUND OF THE INVENTION

### Field of the Invention

The present invention relates to a process for the manufacture of insulation boards based on lignocellulosic fibers bound by means of a polyurea/polyurethane binder.

### Description of the related art including information disclosed under 37 CFR 1.97 and 1.98

For the external thermal insulation of building roofs and walls, it is known to use rigid wood fiberboards having densities of less than about 250 kg/m³ (Duoprotect from the firm Isonat, France). Such rigid insulation boards are described for example in WO 2017/129561.

It is also known to glue wood particles or wood fibers (lignocellulosic fibers) with binders based on polyisocyanates. Among the polyisocyanates most commonly used in the wood fiberboard industry, mention may be made of poly(methylene diphenyl isocyanate) (pMDI, CAS number 9016-87-9) which is a technical grade blend containing 30-80% MDI (methylene diphenyl isocyanate) and higher molecular weight homologues of formula

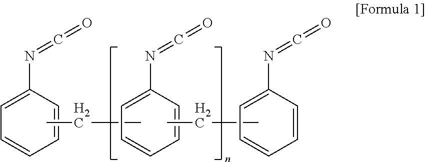

In order to ensure good wetting of lignocellulosic fibers or particles by hydrophobic pMDI, it is generally necessary to subject the fibers to drying first so as to reduce their water content to a value less than or equal to 6% by weight, in particular comprised between 2-6% by weight (see WO 2008/144770).

Proposed more recently are emulsifiable pMDI (EMDI), which are either mixtures of pMDI with non-ionic surfactants free of labile hydrogens capable of reacting with isocyanate functions (see for example EP 0516361), or mixtures of pMDI and a low percentage of pMDI functionalized with hydrophilic chains, for example polyethoxylated chains, to stabilize the emulsion.

The use of pMDI in the form of aqueous emulsions allows an even distribution of the binder on lignocellulosic substrates without preliminary drying, which constitutes a significant energy savings.

However, the use of polyisocyanate-based binders, even in the form of aqueous pMDI emulsions, constitutes a major problem in terms of noxiousness at the board manufacturing site, due to the presence of polyisocyanates.

### BRIEF SUMMARY OF THE INVENTION

The present invention aims to reduce the noxiousness of wood fiberboard bound by polyurethane/polyurea type binders and that of the manufacturing process of such boards by partially replacing the polyisocyanates of the binder compositions by other non-toxic, preferably bio-based reagents, without reducing the mechanical performance of the resulting fiberboard.

In the context of its research aiming to limit the use of polyisocyanates, the Applicant tested a large number of bio-based materials and discovered that it was possible to replace more than half of the polyisocyanate with polyols, in particular with polyhydroxy compounds of natural origin, renewable in the short term, such as carbohydrates, in particular sugars and hydrogenated sugars. To this end, the polyhydroxy compounds, hereinafter also called “polyols”, had to be at least partially water-soluble and dissolved in the aqueous phase of an aqueous emulsion of an emulsifiable pMDI. As will be shown below in the example embodiments, the partial replacement of polyisocyanates with water-soluble polyols has improved the mechanical properties of the final products in certain cases.

All the polyols tested are less expensive than commercially available emulsifiable pMDI and their use in partial replacement of the latter consequently also reduced the manufacturing cost of lignocellulosic fiber-based insulation boards.

The process, the subject matter of the present invention, consequently has the following advantages:
Use of a large fraction of bio-based materials, renewable in the short term,
Reduction of the noxiousness of the insulation boards and of the manufacturing process,
Retention or even improvement of the mechanical performance, in particular rigidity, of insulation boards, and
Significant reduction in insulation board manufacturing costs.

### DETAILED DESCRIPTION OF THE INVENTION

Consequently, the present invention has as its subject matter a process for the manufacture of lignocellulosic fiber-based insulation boards, comprising
(a) Providing lignocellulosic fibers,
(b) Applying a binder composition to the lignocellulosic fibers,
(c) Forming a lignocellulosic fiber mat by compressing the lignocellulosic fibers impregnated with the binder composition,
(d) Heating the compressed lignocellulosic fiber mat so as to obtain a lignocellulosic fiberboard bound by an insoluble and infusible thermoset binder,
said process being characterized by the fact that the binder composition is an emulsion of a poly(methylene diphenyl isocyanate) (pMDI) in an aqueous phase comprising water and a polyol in dissolved form.

Lignocellulosic fibers are understood to mean fibers of plant origin based on lignocellulosic material, i.e. comprising cellulose, hemicellulose and lignin. Lignocellulosic fibers include wood fibers, and fibers from other plants for example hemp fibers, flax fibers, sisal fibers, cotton fibers, jute fibers, coconut fibers, raffia fibers, abaca fibers, cereal straw or rice straw.

The term “lignocellulosic fibers” as used in the present application does not include lignocellulosic materials having been subjected to thermomechanical or chemical treatments for the manufacture of pulp.

The lignocellulosic fibers used in the present invention have therefore simply undergone a mechanical comminution treatment intended to reduce and/or control the dimension of the fibers.

The lignocellulosic fibers are preferably softwood, particularly pine, fibers obtained by mechanical defibration. Their diameter is a few hundred micrometers and they have a length ranging from about 1 to 10 millimeters.

As explained in the introduction, by virtue of the use of an aqueous binder composition in the form of aqueous emulsion, it is not necessary to dry the lignocellulosic fibers prior to the application of the binder composition. The lignocellulosic fibers used, without prior drying, generally have a moisture content comprised between 5 and 15% by weight, in particular between 6 and 10% by weight, often close to 7% by weight.

The binder composition is an aqueous emulsion of an emulsifiable pMDI in an aqueous phase containing water and a polyhydroxy compound, or polyol, i.e. a compound having at least two hydroxyl functions per molecule. The polyhydroxy compound is dissolved in the aqueous phase of the emulsion.

This binder composition is not very stable from a chemical point of view because the isocyanate groups of the pMDI hydrolyse in the presence of water and the resulting amine functions react with the remaining isocyanate functions to give polyureas.

The binder composition is therefore preferably prepared immediately before being applied to the lignocellulosic fibers. The preparation of the binder composition comprises mixing an emulsifiable pMDI (EMDI) with water and the polyhydroxy compound, the latter two compounds preferably being mixed first so as to obtain the dissolution of the polyol. The person skilled in the art is able to determine the shear forces required to obtain a satisfactory, i.e. macroscopically homogeneous emulsion.

In a preferred embodiment, the process of the present application therefore further comprises a step of preparing the binder composition by emulsification of an emulsifiable pMDI in an aqueous phase comprising water and a polyol in dissolved form, said step of preparing the binder composition being carried out preferably at most 20 minutes, more preferentially at most 10 minutes and in particular at most 5 minutes before step (b) of applying the binder composition to the lignocellulosic fibers.

Emulsifiable pMDI, also known as EMDI, is known and commercially available for example under the names Rubinate 9259, Suprasec 1042, Suprasec 2405, Suprasec 2408, Suprasec 2419 or I-Bond MDI 4330, I-Bond WFI 4376 by the firm Huntsman, or under the name Voramer MV 4011 by the firm Dow.

The polyhydroxy compounds, or polyols, are preferably compounds of natural origin, i.e. obtained from biological materials that are renewable in the short term, not derived from the petroleum industry. They are for example carbohydrates selected from reducing and non-reducing sugars. They can also be hydrogenation products of reducing or non-reducing sugars, generally called alditols, sugar alcohols or hydrogenated sugars.

The polyols usable in the present invention can also be alkylene glycols, such as ethylene glycol or propylene glycol, or polyalkylene glycols, i.e. polymers of alkylene glycols, such as polyethylene glycol and polypropylene glycol. The polyalkylene glycols preferably have a weight average molecular weight of less than 500, preferably less than 200, in particular less than 100.

The polyols usable in the present invention also include polyglycerols of formula HO—(CH₂—CHOH—CH₂—O—)ₙ—H where n is advantageously comprised between 2 and 30, preferably between 3 and 20 and in particular between 4 and 15.

In a preferred embodiment of the process of the present application the polyol is therefore selected from the group consisting of reducing sugars, non-reducing sugars, hydrogenated sugars, alkylene glycols, poly(alkylene glycol), polyglycerols and mixtures thereof.

The reducing sugars are for example monosaccharides such as glucose, galactose, mannose and fructose, disaccharides such as lactose, maltose, isomaltose and cellobiose, or starch hydrolysates having a dextrose equivalent (DE) greater than 15, preferably greater than 20, or hydrolysates of lignocellulosic materials.

The non-reducing sugars are preferably disaccharides such as trehalose, isotrehaloses, sucrose and isosucroses. Sucrose is particularly preferred.

The hydrogenated sugars are for example selected from erythritol, arabitol, xylitol, sorbitol, mannitol, iditol, maltitol, isomaltitol, lactitol, cellobitol, palatinitol, maltotritol, glycerol and hydrogenation products of starch hydrolysates or hydrolysates of lignocellulosic materials, in particular hemicellulose, especially xylans and xyloglucans.

In a preferred embodiment, the polyol is selected from the group consisting of hydrogenated sugars, preferably sorbitol, xylitol and glycerol, alkylene glycols, preferably butanediol, polyglycerols and mixtures thereof.

The binder composition used in the process of the present invention preferably has a water content comprised between 5 and 60% by weight, preferably between 10 and 50% by weight and in particular between 15 and 40% by weight. This water content is expressed in relation to the total weight of the composition. It is of course lower than the fraction of the aqueous phase of the composition which also contains the dissolved polyol.

The binder composition used in the process of the present invention comprises from 30 to 60% by weight, preferably from 35 to 55% by weight and in particular from 40 to 50% by weight emulsifiable poly(methylene diphenyl isocyanate), this percentage being in relation to the total weight of the binder composition when applied to the lignocellulosic fibers.

In the binder composition, the weight ratio of polyol to emulsifiable poly(methylene diisocyanate) is advantageously comprised between 10/90 and 70/30, preferably between 15/85 and 65/35, in particular between 20/80 and 60/40. When this ratio is lower than 10/90, the reduction in cost and in noxiousness of the binder composition and the products obtained is insufficient. For reasons that are easy to understand, the aim is generally to achieve the highest possible polyol/pMDI weight ratio. Beyond a certain limit, which depends, inter alia, on the amount of water and on the molecular weight of the reagents, the cured binder will, however, be insufficiently cross-linked because the number of isocyanate functions, reactive towards the hydroxyl groups of the polyol and the water, will be insufficient to form a three-dimensional network sufficiently dense to give the lignocellulosic fiber insulation boards satisfactory mechanical properties.

The binder composition may contain, in addition to the three main ingredients described above (pMDI, polyol, water), a small fraction of one or more functional additives. These additives are selected for example from paraffin wax (in emulsified form), biocidal agents, flame retardants, dyes, mineral fillers, and wetting agents. The total fraction of the various additives does generally not exceed 10% by weight, in particular 5% by weight, of the total weight of the binder composition when applied to the fibers.

The emulsified binder composition can be applied to the lignocellulosic fibers for example by continuous injection of the binder composition into the blow line of the fibers exiting the defibrator.

The binder composition is preferably applied in such an amount that after the thermal curing step (d) the insulation board has a thermoset binder content comprised between 4 and 20% by weight, preferably between 5 and 10%, in relation to the total dry weight of the board.

The process for manufacturing insulation board based on lignocellulosic fibers of the present invention comprises a step of compressing the fibers impregnated with the binder composition and a step of heating the compressed fibers. Although these two steps can in principle be carried out one after the other, it is preferable that they be carried out concomitantly, i.e. simultaneously. Thermal curing of the binder on the board under pressure allows excellent control of the density and the dimensions of the final product.

The heating temperature of the compressed mat of lignocellulosic fibers is generally comprised between 130 and 165° C., preferably between 140° C. and 155° C. This temperature range corresponds to the set temperature of the heating press. The temperatures measured at the core of the material during the thermal curing step are then comprised between about 90 and 120° C.

The reaction of the isocyanate groups with the hydroxyl groups of the polyol and of the lignocellulosic material is very rapid and it is generally sufficient to maintain the above heating temperatures for only a few tens of seconds. The heating time is preferably comprised between 10 seconds and 10 minutes, more preferentially between 20 and 5 minutes and in particular between 30 seconds and 3 minutes.

After compression and heating, or heating under pressure of the lignocellulosic fibers, the fiberboards obtained at the end of step (d) advantageously have a density comprised between 30 and 250 kg/m³, preferably between 50 and 230 kg/m³, in particular between 100 and 200 kg/m³.

### EXAMPLES

All samples are prepared with lignocellulosic fibers of softwood (Douglas pine), provided by the firm Isonat. The moisture content of the fibers is determined by thermogravimetry and is adjusted by adding water up to a moisture content of 7%. The fibers of all the samples therefore have the same water content of 7% by weight.

Binder compositions are prepared by emulsifying emulsifiable pMDI (I-Bond WFI 4376 marketed by Huntsman) with water (comparative example) or with an aqueous phase containing water and polyol (examples according to the invention). It is verified that the pMDI is sufficiently reactive by first determining the rate of isocyanate functions in accordance with standard NF EN ISO 1496. It is in this case comprised between 6.9-7.1 equivalents/kg pMDI.

All the binder compositions contain 40% by weight water and 60% by weight dry matter (pMDI for the comparative example or pMDI+polyol for the examples according to the invention). They are prepared less than 5 minutes before being brought into contact with the lignocellulosic fibers.

For the examples according to the invention, part of the pMDI is replaced by an equivalent weight amount of polyol first dissolved in the aqueous phase.

For each test, 600 mg of lignocellulosic fibers (7% moisture content) are impregnated with 70 mg of binder composition by creating a vortex in a 120 ml vial using a magnetic stirrer (about 1300 rpm, 3 minutes).

217 mg of impregnated fibers are then introduced, less than 30 minutes after impregnation, into steel molds having open cavities measuring 60 mm×10 mm×12 mm and evenly distributed in each mold cavity. Steel bars of 60 mm×10 mm×10 mm are placed over the wood fibers and the whole is heated for 240 seconds in a press thermostatically controlled at 150° C. and under a pressure of 10 bars. The molds are then allowed to cool to room temperature before removing the lignocellulosic chips formed (10×60×2 mm).

The flexural storage modulus (three-point bending) is determined for each chip by dynamic mechanical analysis using a “TA Instruments RSA-G2 Analyzer” device. The samples are first dried for several hours in a desiccator under dynamic vacuum (20 mbar).

The operating parameters of the measuring device are as follows:
Temperature: 25° C.
Poisson's ratio: 0.45
Duration of the oscillating mechanical stress: 120 seconds
Oscillation frequency: 1.0 Hz,
Prestressing: 0.15 N
Sampling speed: 10 points/second

Table 1 below shows the storage modulus of chips prepared with binder compositions containing only pMDI (60%) and water (40%) (comparative example) or with emulsions containing water (40%), pMDI and various polyols (examples according to the invention) used as partial replacement of pMDI. For all the examples according to the invention, the total weight of pMDI and of polyol represents 60% of the binder composition.

The pMDI replacement rate is defined as the weight of polyol relative to the total weight of pMDI+polyol.

Each storage modulus value is the calculated average of two to four individual measurement values.

TABLE 1

| | | Rate of | |
|---|---|---|---|
| | | replacement | |
| | | of pMDI by | Storage |
| Example | Polyol | polyol | modulus |
| Comparative example | — | 0 | 100 MPa |
| Ex 1 according to | butanediol | 26% | 158 MPa |
| the invention | | | |
| Ex 2 according to | butanediol | 30% | 117 MPa |
| the invention | | | |
| Ex 3 according to | butanediol | 40% | 124 MPa |
| the invention | | | |
| Ex 4 according to | glycerol | 20% | 229 MPa |
| the invention | | | |
| Ex 5 according to | glycerol | 26% | 164 MPa |
| the invention | | | |
| Ex 6 according to | glycerol | 32% | 204 MPa |
| the invention | | | |
| Ex 7 according to | sorbitol | 20% | 116 MPa |
| the invention | | | |
| Ex 8 according to | sorbitol | 30% | 129 MPa |
| the invention | | | |
| Ex 9 according to | sorbitol | 40% | 168 MPa |
| the invention | | | |
| Ex 10 according to | sorbitol | 50% | 126 MPa |
| the invention | | | |

It is observed that all the chips obtained with a mixture of pMDI and of polyol were found to have a higher storage modulus than the comparative example. The three polyols used are less expensive than pMDI and replacing the latter reduces the manufacturing cost of the products. Finally, since the three polyols used are perfectly innocuous from a toxicological point of view, replacing pMDI considerably reduces the noxiousness of the products and of the manufacturing process.

1. A process for manufacturing a lignocellulosic fiber-based insulation board, the process comprising:
(a) applying a binder composition to lignocellulosic fibers, to impregnate the lignocellulosic fibers with the binder composition;
(b) compressing the lignocellulosic fibers impregnated with the binder composition, to form a compressed lignocellulosic fiber mat; and
(c) heating the compressed lignocellulosic fiber mat, to obtain a lignocellulosic fiberboard bound by an insoluble and infusible thermoset binder,
wherein the binder composition is an emulsion of an emulsifiable poly(methylene diphenyl isocyanate) (EMDI) in an aqueous phase comprising water and a polyol dissolved therein.

2. The process according to claim 1, wherein the polyol is selected from the group consisting of a reducing sugar, a non-reducing sugar, a hydrogenated sugar, an alkylene glycol, a poly(alkylene glycol), a polyglycerol, and mixtures thereof.

3. The process according to claim 1, wherein the polyol is selected from the group consisting of a hydrogenated sugar, an alkylene glycol, a polyglycerol, and mixtures thereof.

4. The process according to claim 1, wherein the binder composition comprises from 30 to 60% by weight of the emulsifiable poly(methylene diphenyl isocyanate) (EMDI).

5. The process according to claim 1, wherein a weight ratio of the polyol to the emulsifiable poly(methylene diphenyl diisocyanate) (EMDI) is comprised between 10/90 and 70/30.

6. The process according to claim 1, wherein the water content of the binder composition is comprised between 5 and 60% by weight, based on a total weight of the binder composition.

7. The process according to claim 1, wherein that the compressing (b) and the heating (c) are performed concomitantly.

8. The process according to claim 1, wherein the binder composition further comprises one or more additives selected from the group consisting of paraffin wax, a biocidal agent, a flame retardant, a dye, a mineral filler, and a wetting agent.

9. The process according to claim 1, wherein the lignocellulosic fiberboard obtained after the heating (c) has a thermoset binder content comprised between 4 and 20% by weight, based on a total dry weight of the lignocellulosic fiberboard.

10. The process according to claim 1, wherein the lignocellulosic fiberboard obtained after the heating (c) has a density comprised between 30 and 250 kg/m³.

11. The process according to claim 1, wherein the heating temperature of the compressed mat of lignocellulosic fibers is comprised between 130° C. and 165° C.

12. The process according to claim 1, wherein the heating time is comprised between 10 seconds and 10 minutes, preferably between 20 and 5 minutes and in particular between 30 seconds and 3 minutes.

13. The process according to claim 1, further comprising:
emulsifying the emulsifiable poly(methylene diphenyl isocyanate) (EMDI) in an aqueous phase comprising water and the polyol in dissolved form, to obtain the binder composition.

14. The process according to claim 13, wherein the emulsifying is carried out for a time of at most 20 minutes before the applying (b).

15. The process according to claim 1, wherein the lignocellulosic fibers have a moisture content comprised between 5 and 15% by weight.

16. The process according to claim 1, wherein the polyol is selected from the group consisting of sorbitol, xylitol, glycerol, 1,4-butanediol, and mixtures thereof.

17. The process according to claim 1, wherein a weight ratio of the polyol to the emulsifiable poly(methylene diphenyl diisocyanate) (EMDI) is comprised between 15/85 and 65/35.

18. The process according to claim 1, wherein the water content of the binder composition is comprised between 10 and 50% by weight, based on a total weight of the binder composition.

19. The process according to claim 1, wherein the lignocellulosic fiberboard obtained after the heating (c) has a thermoset binder content comprised between 5 and 10% by weight, based on a total dry weight of the board.

20. The process according to claim 1, wherein the lignocellulosic fiberboard obtained after the heating (c) has a density comprised between 50 and 230 kg/m³.
